(19) United States
(12) Patent Application Publication
(10) Pub. No.: US 2019/0019619 A1
(43) Pub. Date: Jan. 17, 2019

(54) Winding Arrangement With Fixed Winding Sections

(71) Applicant: SIEMENS AKTIENGESELLSCHAFT, München (DE)

(72) Inventors: TIM-FELIX MAI, WENDLINGEN (DE); RICHARD SILLE, KIRCHHEIM (DE); STEFFEN WEINERT, WANGEN (DE)

(21) Appl. No.: 16/068,770

(22) PCT Filed: Dec. 15, 2016
(86) PCT No.: PCT/EP2016/081116

§ 371 Date: Jul. 9, 2018

(30) Foreign Application Priority Data
Jan. 15, 2016 (DE) 10 2016 200 477.8

(51) Int. Cl. H01F 27/32; H01F 41/12; H01F 27/30

(52) U.S. Cl. CPC H01F 27/323; H01F 27/327; H01F 27/2847; H01F 41/127; H01F 27/306; H01F 41/122

(57) ABSTRACT

A winding arrangement has a foot support for upright potting. The winding arrangement has a number of winding sections that are arranged on top of one another in the vertical direction and at a spacing distance from one another. The winding sections are electrically connected to form a series circuit. Each winding section has winding layers which are wound one on top of the other. The winding layers are insulated from one another and have an electrical conductor. Slipping of the winding sections is avoided by fixedly connecting the winding layers to one another by a layer connecting devices.

The invention relates to a winding arrangement with a number of winding sections arranged on top of one another in the vertical direction, which are arranged with a spacing from one another and electrically connected to one another, forming a series circuit, wherein each winding section exhibits winding layers which have been wound over one another and which are mutually insulated and exhibit an electrical conductor.

The invention further relates to a method for producing a winding arrangement.

The invention relates furthermore to a transformer and to a choke with such a winding arrangement.

The aforementioned winding arrangement is known from EP 2 251 877 B1, for instance. The winding arrangement shown therein consists of a series circuit of so-called disk-type windings which are arranged with a spacing from one another. In the course of production of such a winding section, a strip conductor, for instance, is wound together with an insulating film from the inside to the outside onto a shaping winding support and is retained thereon by the winding tension.

The previously known winding arrangement has the disadvantage that the winding sections which are retained on the support solely by the winding tension may slip, so that the electrically necessary minimum spacings between the windings are no longer maintained.

It is therefore an object of the invention to provide a winding arrangement and a method of the aforementioned type, with which a slipping of the winding sections is avoided.

Starting from the aforementioned winding arrangement, this object is achieved by the winding layers being firmly connected to one another via a layer-connecting means.

Starting from the aforementioned method, the invention achieves this object by winding sections being wound onto a winding support by winding of winding layers, said winding layers exhibiting mutually insulated electrical conductors, said winding layers being firmly connected to one another by a layer-connecting means, and each winding section being potted with an insulating material, and the winding arrangement formed in this way being heated for the purpose of curing the insulating material.

The winding arrangement according to the invention is provided with winding sections, the winding layers of which are firmly connected to one another via a layer-connecting means. In this way, the layer-connecting means increases the mechanical stability of the winding sections. Within the scope of the invention a slipping of the winding layers after winding is therefore avoided. By way of layer-connecting means, in principle any connecting means enters into consideration that is capable of connecting the winding layers bearing against one another to one another effectively, so that the winding layers remain dimensionally stable and do not slip.

According to a preferred variant of the invention, however, the layer-connecting means is a cured resin compound.

Arbitrary resins enter into consideration for the purpose of forming the resin compound. The resin is, for instance, applied in the incompletely cured state—or, in other words, at the B-stage—onto both sides of the insulating film. After winding, the winding arrangement is cured, for instance by application of heat. The resin is expediently an epoxy resin.

Expediently, an insulating film which has been wound between the conductors of a winding section is impregnated or coated with the layer-connecting means. The insulating film may have been impregnated or coated with the layer-connecting means on one—or, advantageously, on both—of its two sides. Consequently the film that has been provided with layer-connecting means on both sides bonds the conductors, between which it was wound, to one another.

Advantageously, the resin compound is configured to be at least partially punctiform. Such a punctiform compound is also known in specialist circles as “diamond-dotted”; it can be produced easily and quickly and, in addition, exhibits high stability.

According to a further development that is expedient in this regard, each resin compound is of punctiform design.

In a preferred variant of the invention, the winding sections are at least partially surrounded by a fixed winding insulator which consists of a fixed winding-insulating material. By virtue of the embedding into a fixed insulating material, the dielectric strength of the winding arrangement is increased. Such a winding arrangement or dry-type-transformer winding is employed, for instance, as higher-voltage winding in a transformer or in a choke. For this purpose, a lower-voltage winding is placed in the interior of the winding arrangement, through which, in turn, a leg of an iron core extends. The iron core, which is formed from iron sheets, has a lower magnetic resistance than air and serves for guiding the magnetic fields that are generated by the winding arrangement as higher-voltage winding and by the lower-voltage winding arranged in it.

Advantageously, the resin compound has been applied directly onto the winding insulation. In other words, a resin layer has been provided.

Furthermore, it is advantageous if the winding arrangement has been provided with retaining means which exhibit at least one retaining element which extends into winding sections arranged at least between two winding sections arranged side by side. Such a retaining means retains the winding sections, between which it extends, with a certain spacing from one another which is predetermined by reason of the desired dielectric strength of the winding arrangement. During the operation of the winding arrangement, the winding sections are at a high-voltage potential, so that a voltage falls between the winding sections.

According to a further development that is expedient in this regard, each retaining element takes the form of a flat insertable strip. A flat insertable strip can be wound between the winding layers particularly easily and therefore inexpensively in the course of the winding of the winding sections, and can be connected to said winding layers.

Advantageously, each retaining element consists of a resin reinforced with glass fibers. The resin of the retaining element is, for instance, the same resin that is employed for the winding insulation.

In a further variant of the invention, at least one foot element has been provided which has been connected to a winding section and adapted for supporting the entire winding arrangement. The foot element enables the unworked piece of the winding arrangement to be set down, and consequently enables a stationary potting.

According to a further development that is expedient in this regard, each foot element exhibits an insulating-material section that consists of an electrically insulating foot-insulating material. The insulating-material section provides the necessary electrical insulation between the foot end at ground potential and the winding end of the foot element connected to the winding section.

Advantageously, each winding section and each foot element are at least partially surrounded by a winding insulator which consists of a fixed winding-insulating material, the coefficient of thermal expansion of said winding-insulating material corresponding to that of the foot-insulating material. In this way, formations of cracks in the winding insulator are avoided.

Each winding section is advantageously peripherally closed, the winding sections being arranged in alignment with one another. Within the scope of the invention, the winding arrangement is therefore of hollow design inside, so that the accommodation of a lower-voltage winding and/or of a core leg has been made possible.

Expediently, at least one retaining element is introduced between the winding layers in the course of winding, so that it extends between at least two winding sections.

Advantageously, the winding arrangement is preheated after the introduction of the retaining elements but prior to the curing of the insulating material. In the course of this process, the prepregs cure, so that a mechanically stable winding arrangement has been provided which can be potted when stationary without winding support. This enables the formation of a winding insulation with a thicker wall, particularly on its inside, so that higher voltages can be applied to the winding arrangement with the same dimensional design.

Further expedient configurations and advantages of the invention are the subject-matter of the following description of embodiments of the invention with reference to the figures of the drawing, wherein identical reference symbols refer to identically-acting components, and wherein

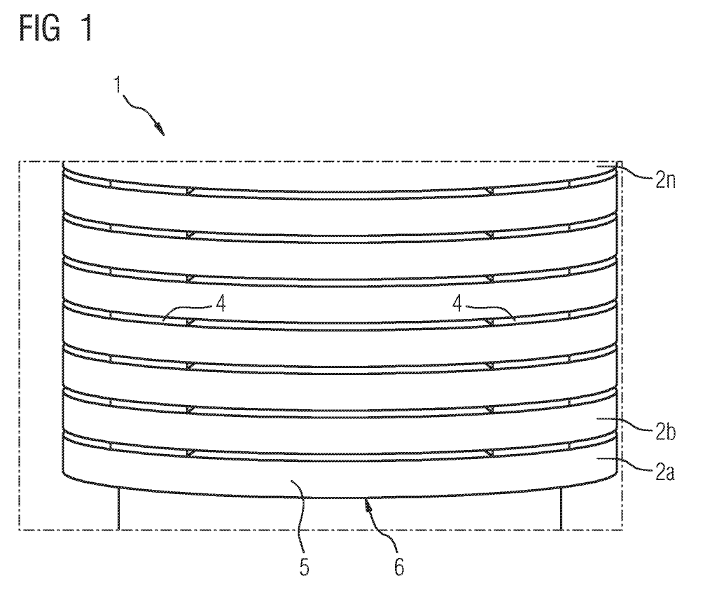

FIG. 1 shows an embodiment of the winding arrangement according to the invention in a perspective view,

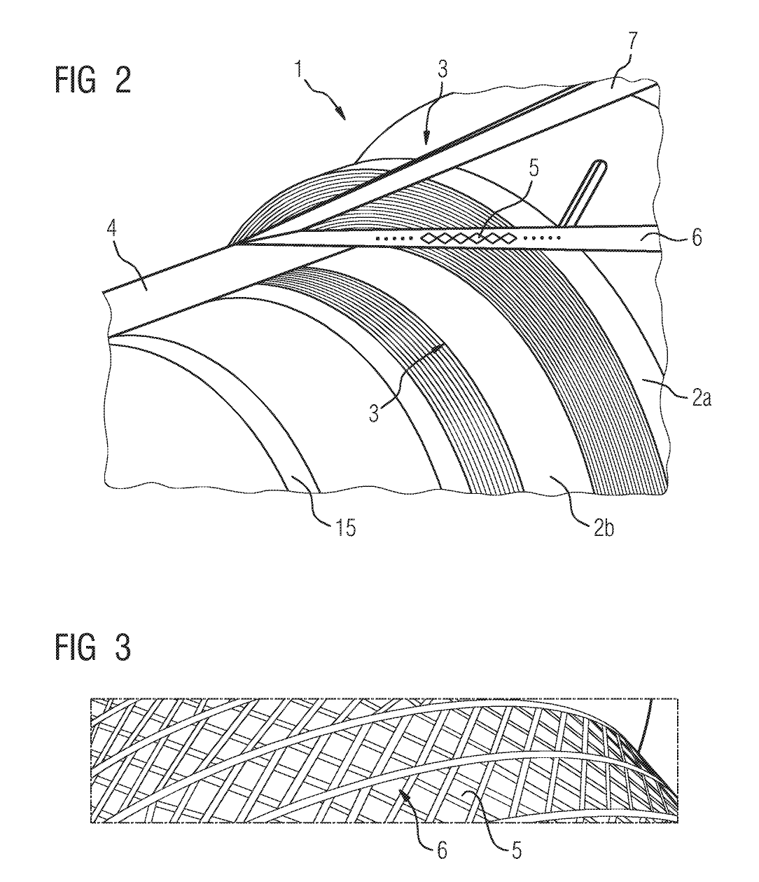

FIG. 2 shows an embodiment of the method according to the invention and

FIG. 3 shows a more detailed view of an insulating film with layer-connecting means.

FIG. 1 shows an embodiment of the winding arrangement 1 according to the invention in a perspective representation. It can be discerned that the winding arrangement 1 exhibits disk-type windings 2a, 2b, . . . , 2n arranged vertically above one another—that is to say, here, in the axial direction—which are electrically connected to one another in series. The disk-type windings 2a are fastened to one another via retaining means and are retained with a spacing from one another. The retaining means are provided with the retaining elements 4 which have been wrapped into the winding sections 2a, 2b, 2n and connected to them in planar manner. By reason of the retaining means 4, the electrically necessary spacings can be maintained. For a later application, the unworked piece of the winding arrangement 1 shown in FIG. 1 is embedded completely into a fixed winding insulator which consists of an expedient winding-insulating material, for instance an expedient casting resin. For this purpose, the unworked piece of the winding arrangement 1 shown in FIG. 1 is arranged in a casting mold, and subsequently the liquid winding-insulating material—for instance, an epoxy resin with additives and fillers—is supplied in liquid form. Subsequently the curing of the winding-insulating material is effected under heat, so that a series circuit of disk-type windings 2a, 2b, 2n, embedded completely in a fixed winding insulation, has been provided. The winding arrangement produced in this way then serves, for instance, as higher-voltage winding of a transformer.

In FIG. 1 the outside of the disk-type windings 2a, 2b, . . . , 2n is shown. In particular, it can be discerned that this outside exhibits layer-connecting means 5 in the form of rhombic regions which have been coated with a resin at a B-stage. Resin at a B-stage is a not yet fully cured resin, which therefore still exhibits open junctions which are available for a later complete polymerization. At this B-stage the resin exhibits adhesive properties.

FIG. 2 shows an embodiment of the method according to the invention, in the course of which the winding arrangement according to FIG. 1 is produced. It can be discerned that disk-type windings 2a and 2b are being wound onto a winding support 15. Each disk-type winding 2a and 2b is composed of winding layers 3 which in the course of winding are wound from the inside to the outside and in the process enlarge each winding section in the radial direction. Each winding layer 3 is provided with a strip conductor 7 which is insulated from the strip conductor of the underlying winding layer 3 by an insulating film 6. The insulating film 6 in this embodiment is realized as a prepreg with layer-connecting means 5 coated over the full surface on both sides. In addition, it can be discerned from FIG. 2 that the retaining means, which consist of a flat insertable strip 4, can be wrapped in straightforward manner into winding section 2b and all the other winding sections. The flat insertable strip 4 consists of glass fibers which have been impregnated with a resin that is likewise at the so-called B-stage—that is to say, in other words, is not yet fully cured. After the winding of all the winding sections—or, in this case, of all the disk-type windings 2a, 2b, . . . , 2n—the winding arrangement 1 is preheated, so that the resin at the B-stage 5 on the film 6 and also the prepreg 4 cure, and in this way a mechanically stable connection has been provided both between the film 6 and the metallic strip conductors 7 and also between the film 6 and the retaining element 4 or the strip conductor 7. Subsequently the winding support 15 can be removed, so that a winding-support-free self-standing winding arrangement 1 has been provided, in which disk-type windings 2a, 2b, . . . , 2n are arranged vertically above one another in the axial direction with a spacing from one another.

FIG. 3 illustrates an embodiment of the layer-connecting means 5 according to the invention on a film 6 which exhibits rhombic regions in which resin 5 at the B-stage has been applied in punctiform manner.

1-17. (canceled)

18. A winding arrangement, comprising:
a plurality of winding sections arranged on top of one another in a vertical direction, said winding sections being spaced from one another and electrically connected to form a series circuit;
each of said winding sections being formed of winding layers that have been wound over one another, said winding layers being insulated from one another and containing an electrical conductor; and
layer connection devices firmly connecting said winding layers to one another.

19. The winding arrangement according to claim 18, wherein said layer-connecting devices are formed of a cured resin compound.

20. The winding arrangement according to claim 19, wherein said resin compound is configured to be at least partially punctiform.

21. The winding arrangement according to claim 20, wherein each said resin compound has a punctiform shape.

22. The winding arrangement according to claim 21, wherein said resin compound is applied directly onto a winding insulation of said winding layers.

23. The winding arrangement according to claim 18, which comprises a fixed winding insulator at least partly surrounding said winding sections, said winding insulator consisting of a fixed winding-insulating material.

24. The winding arrangement according to claim 18, which comprises at least one retaining element that extends into at least two mutually adjacent winding sections, said retaining element being firmly connected to said winding sections into which said retaining element extends.

25. The winding arrangement according to claim 24, wherein each said retaining element is a flat insertable strip.

26. The winding arrangement according to claim 25, wherein each said retaining element consists of a resin reinforced with glass fibers.

27. The winding arrangement according to claim 18, which comprises at least one foot element connected to one of said winding section and disposed for supporting said plurality of winding sections.

28. The winding arrangement according to claim 27, wherein said at least one foot element comprises an insulating-material section formed of an electrically insulating foot-insulating material.

29. The winding arrangement according to claim 27, wherein each said winding section and said at least one foot element are at least partially surrounded by a winding insulator of a fixed winding-insulation material, and wherein a coefficient of thermal expansion of said winding-insulation material is substantially equal to a coefficient of thermal expansion of said foot-insulating material.

30. The winding arrangement according to claim 18, wherein each said winding section is peripherally closed, and said plurality of said winding sections are arranged in alignment with one another.

31. A method of producing a winding arrangement, the method which comprises:
forming winding sections by winding winding layers onto a winding support, the winding layers having electrical conductors insulated from one another;
firmly connecting said winding layers to one another;
casting each winding section with a winding-insulating material; and
heating the winding arrangement thus formed for curing the winding-insulating material.

32. The method according to claim 31, which comprises, prior to curing the insulating material, bonding the winding layers to one another with an incompletely cured resin.

33. The method according to claim 31, which comprises introducing at least one retaining element between the winding layers during the winding, so that the at least one retaining element extends between at least two winding sections.

34. The method according to claim 33, which comprises preheating the winding arrangement after introducing the retaining element(s) but prior to curing the insulating material.
